(19) United States
(12) Patent Application Publication
(10) Pub. No.: US 2005/0080145 A1
(43) Pub. Date: Apr. 14, 2005

(54) Method and compositions for rheology modification of aqueous soluble salt solutions

(76) Inventor: Edgar Franklin Hoy, Kingwood, TX (US)

Correspondence Address: Barbara J. Tribble, 112 Pansy Path, Lake Jackson, TX, 77566-4730, US

(21) Appl. No.: 10/756,590

(22) Filed: Jan. 13, 2004

Related U.S. Application Data
(60) Provisional application No. 60/509,789, filed on Oct. 9, 2003.

(51) Int. Cl. B01F 3/08

(52) U.S. Cl. 516/52

(57) ABSTRACT

A method of making a rheology modified aqueous salt solution includes adding thereto, a non-hydratable clay, as defined, and at least one compound capable of contributing, in solution, a divalent metal cation and a trivalent metal cation; and then adjusting the pH to a specific range. A dry composition comprising at least one compound capable of contributing the designated cations and, optionally, the non-hydratable clay is also disclosed. This invention is particularly applicable to drilling fluids, and more particularly to such fluids used in coastal and deepsea drillsites where the presence of salinity has been heretofore known to significantly reduce the effectiveness of clays as thickening agents.

### BACKGROUND OF THE INVENTION

1. Field of the Invention

This invention relates to rheology modification of fluids used in oilfield and construction boring applications, including, for example, drilling, milling and mining. More particularly, it relates to the use of additives to modify the rheology of aqueous soluble salt solutions, such as brines and sea water.

2. Background Art

In the rotary drilling of wells, a drilling fluid is introduced into the wellbore to remove cuttings, to cool the drill bit and to seal formations. The drilling fluid, or drilling mud as it is also called, must be sufficiently viscous to carry the cuttings from the well bore and to suspend particles of weighting agent. However, the mud viscosity should not be high enough to interfere with the action of pumps which circulate the drilling fluid in the formation. To achieve this balance, it is generally preferred that the viscosity of the drilling fluid be from about 10 to about 40 centipoise (cp), frequently about 15 to about 30 cp, at 600 revolutions per minute (rpm) and 20° C.

In order to attain a desired increase in mud viscosity, colloidal clays are generally employed. The mud-making potential of a clay is known to be indicated by certain properties of an aqueous suspension of the clay. Among the most important of these properties is the yield point. Yield point is determined using a procedure set forth in the American Petroleum Institute's API Bulletin, designated Procedure RP-13B. The yield point of a given mud, reported as pounds per 100 square feet (lb/100 ft²), is determined by subtracting the “plastic viscosity” (pv) from the 300 rpm Fann dial reading. The pv itself is determined by subtracting the 300 rpm Fann dial reading from the 600 rpm reading. In general, the higher the Fann dial reading for a given mud, the higher will be its yield point.

It is desirable to mak up drilling muds at low solids contents, in order to obtain faster bit penetration rates. Therefore, it is highly advantageous to utilize a clay exhibiting the highest yield point available. However, in selecting the clay, careful consideration must also be given to the ability of the clay to tolerate contamination encountered during drilling, without appreciable yield point reduction. Such contamination frequently includes salts which are present in, or may themselves make up, the geological formations being excavated. If a given mud's yield point decreases appreciably upon such contamination, higher clay solids will be needed to accomplish the goal of successfully suspending the cuttings in the well bore, thus undesirably decreasing bit penetration rates.

Despite the challenges noted hereinabove, there exist a wide variety of clay candidates for mud preparation. These include clays which swell appreciably (i.e., increase their volume by an amount of at least about 8 times) in contact with fresh water, but do not comparably swell in contact with salt water, and those which do not swell appreciably in either fresh water or salt water. As used herein, the term “non-hydratable clays” include clays of both of these categories.

Those swelling appreciably in contact with fresh water, but not when in contact with salt water, include, for example, clays containing sodium montmorillonite, such as bentonite. These clays work well for fresh water systems, but are highly contraindicated when a drilling mud must be made up with sea water or brine (as for example, in certain coastal drilling operations), because the presence of ions typical in such media is known to prevent their swelling. In other words, sodium montmorillonite clays are “non-hydratable”, as defined, in salt water. Such clays are also contraindicated for use in drilling formations containing salt, gypsum, anhydrite and the like because the ions therein hinder the clay's ability to swell.

Because of the problems encountered in using the “non-hydratable” clays such as bentonites in preparing muds from aqueous salt solutions such as sea water and brine, those skilled in the art have learned to substitute a clay called attapulgite in such systems. Interestingly, attapulgite is considered to be non-hydratable, as defined, in both fresh and salt water, but still operates to thicken salt solutions. This thickening is attributed to what is believed to be a unique orientation of charged colloidal attapulgite particles in the dispersion medium, and not actual “hydration”. However, attapulgite is relatively expensive and treatments to improve its performance in aqueous salt solutions, including, for example, extrusion to optimize the presence of colloidal-sized particles, further increase its cost.

Accordingly, what is needed in the art is a relatively inexpensive and convenient means of modifying the rheology of aqueous soluble salt systems using a variety of clays, including but not limited to bentonite and attapulgite, that are defined as “non-hydratable” in such systems.

### BRIEF SUMMARY OF THE INVENTION

The present invention provides, in one embodiment, a method of modifying the rheology of an aqueous soluble salt solution comprising adding thereto a non-hydratable clay, as defined, and at least one compound contributing in solution a divalent metal cation, selected from Mg²+Ni²⁺, Be²⁺, Sr²⁺, Ba²⁺, Cu²⁺ and Zn²⁺, and a trivalent metal cation, selected from Al³⁺, Fe³⁺, Co³⁺, Cr³⁺, and Ga³⁺. Each cation is present in the solution in a total amount of at least about 1,500 ppm. Following adding such compound(s), the pH is adjusted to from about 5.0 to about 12.0. The result is a rheology-modified aqueous soluble salt solution.

In another embodiment the present invention provides a dry composition for modifying the rheology of an aqueous soluble salt solution comprising at least one compound capable of contributing in solution a divalent and trivalent metal cation selected from the lists hereinabove, and, optionally, a non-hydratable clay.

Finally, in still another embodiment the present invention provides a rheology-modified aqueous soluble salt composition comprising an aqueous soluble salt solution; a non-hydratable clay in an amount of from about 0.5 to about 15 percent by weight, based on the total weight of the composition, and at least one compound capable of contributing a divalent and trivalent cation selected from the lists given hereinabove. In this embodiment the cations are present in a 1:20 to 8:1 mole ratio and in an amount from about 0.005 to about 4 percent by weight, based on the total weight of the composition. The composition has a pH from about 9 to about 11.

These and other embodiments will be described hereinbelow in greater detail and specific example.

### DETAILED DESCRIPTION OF THE INVENTION

The present invention solves the problems encountered by the prior art in effective thickening of aqueous soluble salt solutions, including but not limited to sea water and other brines, by using specific additives to produce the rheology behavior known as “shear-thinning”. This means that, when undisturbed, the fluid maintains a gel-like, elastic solid consistency, but almost instantly thins to approach the viscosity of the aqueous soluble salt solution (as it would have been without the additives) upon application of a stress. This stress is, in the oilfield as well as in certain milling, mining and construction boring applications, induced by application of pumping and/or rotary drilling forces. When the stress ceases, the viscosity increases again very rapidly, such that the rheology modified aqueous solution returns to the elastic solid state.

This control of the viscosity according to application or cessation of stress offers a number of advantages in drilling, milling and mining applications. Of particular advantage is the fact that the fluid is capable of rapidly suspending particles including formation cuttings, which prevents them from falling to the bottom of the wellbore when pumping is stopped. This is important because of the potential of the cuttings making it more difficult or even impossible to reinitiate drilling. The elastic solid nature also greatly decreases the likelihood of formation penetration and fluid loss, while the ability to shear-thin reduces wear and tear on pumping and drilling equipment. Good or excellent performance in aqueous soluble salt solutions enables use in offshore and coastal wells which, heretofore, were not effectively thickened due to the fact that the presence of salts prevented effective clay swelling. The invention also offers improvements in fluid loss control and reduction in interference with temperature stability when compared with some other rheology modified fluids.

The present invention provides these advantages, and overcomes these problems, by including a unique combination of specific ions in the aqueous salt and clay solution, along with a pH adjustment. Without wishing to be bound by any explanation of the mechanism of its operation, it is believed that the invention does not enable actual swelling of the non-hydratable clays, defined as those clays that either do not swell at all, or swell to a volume of less than about 8 times their dry volume, in aqueous salt solution. Rather, the present invention is hypothesized to produce an unexpected and surprising ordering of the clay, water and salt molecules that results in bridging effects which, in turn, result in thickening of the composition. This effect can be made even more dramatic when the clay is post-added, i.e., added to the aqueous soluble salt solution after (rather than prior to or concurrent with) the inventive combination of specific divalent and trivalent ions. In particularly preferred embodiments, selection of certain specific non-hydratable clays as defined, particularly those with a high sodium montmorillonite content, such as bentonite, exhibit a particularly enhanced thickening effect when post-added, suggesting a notable synergism between the ions and the clay molecules.

In the practice of the present invention a first component is an aqueous soluble salt solution. Such solution can be simple sea water, the salinity of which falls within the range of any of the world's sea waters. In general, salinity of sea water tends to be relatively higher in equatorial areas with a progression to lower levels in polar regions. The range is generally from about 1 percent to about 4.2 percent salt by weight based on total volume of sea water. The specific anions found in sea water include chlorides, bromides, iodides, chlorates, bromates, formates, nitrates, oxides, fluorides, combinations thereof, and the like. Cations of these salts may include sodium, calcium, sulphur, aluminum, magnesium, potassium, strontium, silicon, lithium, phosphorus, combinations thereof, and the like. In fact, most elements of the Periodic Table are found in sea water at at least trace levels, in both combined and uncombined form. Use of sea water, whether in a natural or synthetic form, as at least one component of a drilling mud, and therefore as the aqueous soluble salt solution of the present invention, is obviously relatively inexpensive and is particularly convenient in drilling coastal and deep-sea sites.

Also within the scope of the present invention are brines. A brine is defined herein as any aqueous saline solution. Thus, sea water is one type of brine, but the brine category is much broader, including aqueous solutions wherein the salt concentration is less than or greater than that of sea water. Salts that may be incorporated in a given brine include any one or more of those described hereinabove as present in sea water. Brines may be natural or synthetic, with synthetic brines tending to be much simpler in constitution. Coastal drillsites are particularly likely to encounter, and therefore to also have conveniently available, high salt concentration brines due to the effect of evaporation, particularly in estuaries and in coastal marshes.

The present invention also employs a clay defined as “non-hydratable”. As used herein, the term “non-hydratable” refers to the clay's characteristic lack of swelling, i.e., measurable volume increase, in the presence of salt water. To determine a given clay's swellability, it is tested by a procedure described in an article by K. Norrish, published as “The swelling of Montmorillonite,” Disc. Faraday Soc. vol. 18, 1954 pp. 120-134. This test involves submersion of the clay for about 2 hours in a solution of deionized water and about 4 percent sodium chloride by weight per volume of the salt solution. A “non-hydratable” clay is defined as one that, under this test, swells less than 8 times by volume compared with its dry volume. In a majority of cases, swelling is much less, on the order of less than 2 times, preferably less than 0.3 times, most preferably less than 0.2 times. Among useful and preferred non-hydratable clays in the present invention are attapulgite and attapulgite-containing clays such as Fuller's earth; sodium montmorillonite and sodium montmorillonite-containing clays such as bentonite; calcium montmorillonite; chlorites; kaolinites; illites; combinations thereof, and the like. Preferred among these are attapulgite and the attapulgite-containing clays, and sodium montmorillonite and the sodium montmorillonite-containing clays.

A third component of the present invention includes at least one selection each from two particular cation categories. These categories are the divalent cations, including Mg²⁺, Ni²⁺, Be²⁺, Sr²⁺, Ba²⁺, Cu²⁺ and Zn²⁺, and the trivalent cations, including Al³⁺, Fe³⁺, Co³⁺, Cr³⁺, and Ga³⁺. Of these, the more preferred divalent cations are Mg²⁺ and Ni²⁺, and the more preferred trivalent cations are Al³⁺ and Fe³⁺. Some natural aqueous salt solutions such as sea water inherently contain these cations, but generally at much lower levels than are needed to accomplish the present invention. The addition protocol can consist of adding one compound containing both cations, such as MgAl(OH)₅; or adding at least two compounds, each having at least one of the cations. A compound capable of contributing the divalent metal cation is preferably selected from the group consisting of MgCl₂, Mg(NO₃), MgBr₂, Mgl₂, MgSO₄ (also known as Epsom salts), Mg(HCO₂)₂, Mg(C₂H₃O)₂, NiCl₂, Ni(NO₃), NiBr₂, Nil₂, NiSO₄, Ni(HCO₂)₂, Ni(C₂H₃O)₂, and hydrates thereof; combinations thereof; and the like. Of these MgSO₄ is preferred. A compound capable of contributing a trivalent metal cation in solution is preferably selected from the group consisting of AlCl₃, Al₂(NO₃)₃, Al₂(SO₄)₃ (also known as alum), Al₃(HCO₂)₂, Al₃(C₂H₃O)₂, FeCl₃, Fe₂(NO₃)₃, Fe₂(SO₄)₃, Fe₃(HCO₂)₂, Fe₃(C₂H₃O)₂, and hydrates thereof; combinations thereof; and the like. Of these Al₂(SO₄)₃ is preferred. It is generally preferred to select compounds that exhibit relatively high solubility in the selected aqueous soluble salt solution. Such solubility is preferably at least about 90 percent, more preferably at least about 95 percent, by weight based on total weight of the compound or compounds and the aqueous soluble salt solution.

As already noted, once the identified cations have been introduced, in appropriate amount, into the aqueous soluble salt solution to be used, it is necessary to adjust the pH to achieve a level of at least about 5, preferably at least about 9, most preferably at least about 9.5, to about 12, preferably to about 11, most preferably to about 10.5. Sea water has a natural pH of from about 6 to about 8, and the addition of clay may slightly adjust this pH. Addition of the selected cation compound or compounds (preferably prior to addition of the clay) to the aqueous soluble salt solution will also affect pH, because the compound or compounds being added are either salts of weak bases or strong acids. Because of this fact it is preferred to completely solubilize the cation compounds in the aqueous soluble salt solution first, prior to carrying out the pH adjustment.

Preferably pH adjustment is accomplished by adding an appropriate amount of sodium hydroxide, such being inexpensive and easily available. However, alternatively another base, such as, for example, potassium hydroxide, sodium carbonate, calcium hydroxide or a mixture thereof, can be used. In one particularly preferred embodiment a mixture of calcium hydroxide and sodium carbonate, which produces sodium hydroxide in situ, is used.

In the present invention the presence of the identified cations, along with the establishment of a relatively high hydroxyl content induced by pH adjustment, serves to dramatically increase the interaction of the clay, water and salt molecules to produce the desired thickening. This reduces the amount of clay solids that will be needed to attain a given, desired viscosity level. In addition, the initiation of the bridging interaction of these clays is accompanied by the imparting of a shear-thinning capability. It is hypothesized that these cations operate, in conjunction with the substantial hydroxyl content, to induce a particular and unique, possibly semi-crystalline orientation of charged colloidal clay particles in the solution which is broken up by the introduction of a stress, but is rapidly reproduced when the stress is terminated.

In general it is desirable that the proportions of the cations fall within a specified range. Thus, it is preferred that the proportion of either of the required cations, if any, inherently present in the aqueous salt solution be determined prior to addition of more of such cation-containing compound. For example, sea water typically contains from about 1000 to about 1300 ppm of magnesium, or Mg²⁺, cation. However, in the present invention it is preferred that the Mg²⁺ cation be present in an amount from about 2,000, more preferably from about 2,200, still more preferably from about 2,300 to about 4,000, more preferably to about 3,000, still more preferably to about 2,500 ppm.

Similarly, sea water typically includes from about 0.0003 to about 0.0004 ppm of aluminum, or Al³⁺, cation. However, in the present invention, it is preferred that the Al³⁺ +ation be present in an amount comparable to that of the Mg²⁺ cation, which is preferably from about 2,000, more preferably from about 2,200, still more preferably from about 2,300 to about 4,000, more preferably to about 3,000, still more preferably to about 2,500 ppm. It is also preferred that the (combined) weight of the compound or compounds contributing the Mg²⁺ and Al³⁺ cations in solution range from about 0.005 to about 4 percent by weight, based on total weight of the aqueous soluble salt solution. Thus, in the case of sea water it is generally necessary to add materials to ensure that there are adequate Mg²⁺ and Al³⁺ cations in situ to ensure appropriate effect in conjunction with the selected non-hydratable clay. It is incidentally important to note that, while there may be a proportion of magnesium, in particular, present in certain clays, such is known to those skilled in the art to be generally not soluble in the clay-salt-and-water system. Because of this, such magnesium (or other divalent or trivalent cations, such as Al³⁺ or Fe³⁺) do not need to be taken into account in calculating the proportion of cations to be added to the system.

It is also preferred that, in the case of dry formulations, the mole ratio of divalent to trivalent cations range from about 1:20 to about 8:1, more preferably from about 1:4 to about 3:1, and most preferably from about 1:2 to about 2:1.

It is also preferred that the amount of the non-hydratable clay, regardless of selection, be from about 0.5 to about 15, more preferably from about 1 to about 7, and most preferably from about 2 to about 5, percent by weight, based on total weight of the clay and solution, i.e., of the rheology modified aqueous soluble salt solution. This translates to a level of from about 7 to about 20 pounds of clay per barrel of aqueous soluble salt solution. Generally, it is desirable to use the lowest amount of clay possible, for both economic and performance reasons. However, to ensure adequate clay presence to effect a rheology useful to a wide variety of drilling, milling and mining applications, the preferred ranges are given.

There are a number of preferred embodiments of the present invention. One such embodiment employs sea-water; from about 1,500 to about 3,000 ppm of Mg²⁺; from about 1,500 to about 3,000 of Al³⁺, such that the ratio of Mg²⁺ to Al³⁺ cations is close to 1:1; from about 2.4 to about 3.0 weight percent of attapulgite, based on total weight of clay and aqueous salt solution; and use of sufficient sodium hydroxide to adjust the pH to about 10.

The following examples are provided to further illustrate the present invention and are not meant to be, nor should they be construed as being, limitative in any way of its various embodiments.

### EXAMPLE 1

To about 338 lb of sea-water is added about 12 lb of attapulgite clay and mixed for about 20 minutes. To this is added about 2 lb of a 1:1 ratio mixture of MgSO₄ and Al₂(SO₄)₃. In this amount the MgSO₄ and Al₂(SO₄)₃ mixture contributes about 2,500 ppm of Mg²⁺ cation and about 2,500 ppm of Al³⁺ +ation. A sufficient amount of a 50 percent sodium hydroxide solution is then added to obtain a pH of about 9.5.

### COMPARATIVE EXAMPLE A

To about 338 g of sea water is added about 12 g of attapulgite clay and mixed for 20 minutes using a Hamilton Beach mixer on medium speed. The rheology is checked using a Fann 35 viscometer with the following direct dial readout results. The pH of the mixture is 8.5.

| RPM* | Dial Readout |
|---|---|
| 600 | 12 |
| 300 | 10 |
| 6 | 6 |
| 3 | 4 |

*revolutions per minute
Yield point is 8 lb/100 ft².

### COMPARATIVE EXAMPLE B

Using the solution of Comparative Example A, about 0.2 g of a 50 percent sodium hydroxide solution is added to raise the pH to 10.5. The viscosity is rechecked using the Fann 35 viscometer with the following direct dial readout results.

| RPM | Dial Readout |
|---|---|
| 600 | 12 |
| 300 | 10 |
| 6 | 6 |
| 3 | 4 |

Yield point is 8 lb/100 ft².

### EXAMPLE 2

A dry mixture of 1 g of MgSO₄ and 1 g of Al₂(SO₄)₃ is prepared. This mixture is added to the solution of Comparative Example A, and the resulting pH is increased to 9.5 by adding about 1 g of a 50 percent by volume sodium hydroxide solution. The resulting solution is mixed for about 10 minutes. The rheology is then rechecked using the Fann 35 viscometer with the following direct dial readout results.

| RPM | Dial Readout |
|---|---|
| 600 | 30 |
| 300 | 28 |
| 6 | 20 |
| 3 | 18 |

Yield point is 26 lb/100 ft².

### EXAMPLE 3

About 4 g of GOLD SEAL Wyoming bentonite clay is post-added to the solution produced in Example 1 and mixed for an additional 20 minutes. (GOLD SEAL is a tradename of Baroid Corporation.) GOLD SEAL Wyoming bentonite has about 97-99 percent by weight of sodium montmorillonite. The rheology is then checked using the Fann 35 viscometer with the following direct dial readout results.

| RPM | Dial Readout |
|---|---|
| 600 | 70 |
| 300 | 60 |
| 6 | 35 |
| 3 | 32 |

Yield point is 50 lb/100 ft².

### EXAMPLE 4

A dry mixture of about 0.5 g MgCl₂ and about 0.65 g AlCl₃, a 1:1.1 Mg:Al mole ratio mixture, is prepared. This mixture is added to the solution of Comparative Example A, and the resulting pH is increased to 9.5 by adding about 1 g of a 50 percent by volume sodium hydroxide solution. The resulting solution is mixed for about 10 minutes. Fluid loss is determined, via the procedure described in Manual of Drilling Fluids Technology, 1985, NL Baroid/NL Industries, Inc., and found to be uncontrolled, i.e., greater than 75 ml. The rheology is then checked using the Fann 35 viscometer with the following direct dial readout results.

| RPM | Dial Readout |
|---|---|
| 600 | 28 |
| 300 | 26 |
| 6 | 19 |
| 3 | 17 |

Yield point is 24 lb/100 ft².

### EXAMPLE 5

A dry mixture of about 0.5 g Mg(NO₃)₂ and about 0.65 g Al₂(NO₃)₃, a 1:1.1 Mg:Al mole ratio mixture, is prepared. This mixture is added to the solution of Comparative Example A, and the resulting pH is increased to 9.5 by adding about 1 g of a 50 percent by volume sodium hydroxide solution. The resulting solution is mixed for about 10 minutes. Fluid loss is determined via the procedure as indicated in Example 4 to be about 55 ml. The rheology is then checked using the Fann 35 viscometer with the following direct dial readout results.

| RPM | Dial Readout |
|---|---|
| 600 | 31 |
| 300 | 29 |
| 6 | 20 |
| 3 | 18 |

Yield point is 27 lb/100 ft².

### EXAMPLE 6

The procedure of Example 5 is followed except that about 4 g of a commercial carboxymethylated starch fluid loss additive sold by Chemstar Corporation under the tradename “Starpack II P3223” is added, followed by an additional 10 minutes of mixing, prior to performing the fluid loss test as indicated in Example 4 and also rheological testing. Fluid loss is determined to be 22 ml. Rheology results obtained are as follows:

| RPM | Dial Readout |
|---|---|
| 600 | 52 |
| 300 | 46 |
| 6 | 30 |
| 3 | 28 |

*revolutions per minute Yield point is 40 lb/100 ft².

In the foregoing specification, the invention has been described with reference to specific embodiments thereof, and has been demonstrated as effective in preparing a rheology modified aqueous soluble salt solution. However, it will be evident that various modifications and changes can be made to the steps and components used in the method and compositions without departing from the broader spirit or scope of the invention as set forth in the appended claims. Accordingly, the specification is to be regarded in an illustrative rather than a restrictive sense. For example, specific combinations of cation-containing additives falling within the claimed parameters, but not specifically identified or tried in particular compositions, are anticipated and expected to be within the scope of this invention.

1. A method of modifying the rheology of an aqueous soluble salt solution comprising adding to an aqueous soluble salt solution a non-hydratable clay and at least one compound contributing in solution a divalent metal cation, selected from Mg²+Ni²⁺, Be²⁺, Sr²⁺, Ba²⁺, Cu²⁺ and Zn²⁺, and a trivalent metal cation, selected from Al³⁺, Fe³⁺, Co³⁺, Cr³⁺, and Ga³⁺, each cation being present in the solution in a total amount of at least about 1,500 ppm; and then adjusting the pH to from about 5.0 to about 12.0; to form a rheology-modified aqueous soluble salt solution.

2. The method of claim 1 wherein the aqueous soluble salt solution is selected from the group consisting of natural and synthetic brines.

3. The method of claim 2 wherein the brine is sea water.

4. The method of claim 1 wherein the non-hydratable clay is selected from the group consisting of attapulgite and attapulgite-containing clays, sodium montmorillonite and sodium montmorillonite-containing clays, chlorites, kaolinites, illites, and combinations thereof.

5. The method of claim 4 wherein the clay is Fuller's earth, bentonite, or a combination thereof.

6. The method of claim 1 wherein the compound contributing a divalent cation in solution is selected from the group consisting of MgCl₂, Mg(NO₃), MgBr₂, Mgl₂, MgSO₄, Mg(HCO₂)₂, Mg(C₂H₃O)₂, NiCl₂, Ni(NO₃), NiBr₂, Nil₂, NiSO₄, Ni(HCO₂)₂, and Ni(C₂H₃O)₂; hydrates thereof; and combinations thereof.

7. The method of claim 1 wherein the compound contributing a trivalent cation in solution is selected from the group consisting of AlCl₃, Al₂(NO₃)₃, Al₂(SO₄)₃, Al₃(HCO₂)₂, Al₃(C₂H₃O)₂, FeCl₃, Fe₂(NO₃)₃, Fe₂(SO₄)₃, Fe₃(HCO₂)₂, and Fe₃(C₂H₃O)₂; hydrates thereof; and combinations thereof.

8. The method of claim 1 wherein the pH is adjusted to from about 9 to about 11.

9. The method of claim 1 wherein at least one cation is present in an amount of from about 2,300 to about 2,500 ppm.

10. The method of claim 1 wherein the clay is present in an amount of from about 0.5 to about 15 weight percent, based on the weight of the rheology-modified aqueous soluble salt solution.

11. The method of claim 1 wherein the weight of the compound or compounds contributing the divalent and trivalent metal cations in solution is from about 0.005 to about 4 weight percent, based on the weight of the rheology-modified aqueous soluble salt solution.

12. The method of claim 1 wherein the non-hydratable clay is attapulgite, in an amount of from about 2.4 to about 3 weight percent; the divalent metal cation is Mg²⁺ and it is in an amount of from about 1,500 to about 3,000 ppm; the trivalent metal cation is Al³⁺ and it is in an amount of from about 1,500 to about 3,000 ppm; and the pH is adjusted to about 10.

13. The method of claim 1 wherein the divalent and trivalent metal cations are added to the aqueous soluble salt solution first, then the clay is added, and then the pH is adjusted.

14. The method of claim 13 wherein the clay is or contains sodium montmorillonite.

15. A dry composition for modifying the rheology of an aqueous soluble salt solution comprising at least one compound capable of contributing in solution a divalent metal cation, selected from Mg²+ Ni²⁺, Be²⁺, Sr²⁺, Ba²⁺, Cu²⁺ and Zn²⁺, and a trivalent metal cation, selected from Al³⁺, Fe³⁺, Co³⁺, Cr³⁺, and Ga³⁺; and, optionally, a non-hydratable clay.

16. The dry composition of claim 15 wherein the compound capable of contributing an Mg²⁺ cation is selected from the group consisting of MgCl₂, Mg(NO₃), MgBr₂, Mgl₂, MgSO₄, Mg(HCO₂)₂, Mg(C₂H₃O)₂, hydrates thereof, and combinations thereof; the compound capable of contributing an Ni²⁺ cation is selected from the group consisting of NiCl₂, Ni(NO₃), NiBr₂, Nil₂, NiSO₄, Ni(HCO₂)₂, and Ni(C₂H₃O)₂, hydrates thereof, and combinations thereof; the compound capable of contributing an Al³⁺ cation is selected from the group consisting of AlCl₃, Al₂(NO₃)₃, Al₂(SO₄)₃, Al₃(HCO₂)₂, Al₃(C₂H₃O)₂, hydrates thereof, and combinations thereof; and the compound capable of contributing a Fe³⁺ cation in solution is selected from the group consisting of FeCl₃, Fe₂(NO₃)₃, Fe₂(SO₄)₃, Fe₃(HCO₂)₂, and Fe₃(C₂H₃O)₂, hydrates thereof, and combinations thereof.

17. The dry composition of claim 16 wherein the compound capable of contributing an Mg²⁺ cation is MgSO₄, and the compound capable of contributing an Al³⁺ +ation is Al₂(SO₄)₃.

18. A rheology-modified aqueous soluble salt composition comprising an aqueous soluble salt solution; a non-hydratable clay in an amount of from about 0.5 to about 15 percent by weight, based on the total weight of the composition; and at least one compound capable of contributing in solution a divalent cation selected from Mg²+, Ni²⁺, Be²⁺, Sr²⁺, Ba²⁺, Cu²⁺ or Zn²⁺, and a trivalent metal cation, selected from Al³⁺, Fe³⁺, Co³⁺, Cr³⁺, or Ga³⁺ in solution; provided that the divalent and trivalent cations are present in a 1:20 to 8:1 mole ratio and in an amount of from about 0.005 to about 4 percent by weight, based on the total weight of the composition; and wherein the rheology-modified aqueous composition has a pH from about 9 to about 11.

19. The rheology-modified aqueous composition of claim 18 wherein at least two compounds are used, including a first compound selected from the group consisting of MgCl₂, Mg(NO₃), MgBr₂, MgSO₄, NiCl₂, Ni(NO₃), NiBr₂, NiSO₄, hydrates thereof, and combinations thereof; and a second compound selected from the group consisting of AlCl₃, Al₂(NO₃)₃, Al₂(SO₄)₃, FeCl₃, Fe₂(NO₃)₃, Fe₂(SO₄)₃, hydrates thereof, and combinations thereof.

20. The rheology-modified aqueous composition of claim 18 wherein the non-hydratable clay is selected from the group consisting of attapulgite or an attapulgite-containing clay, sodium montmorillonite or a sodium-montmorillonite-containing clay, a chlorite, kaolinite, illite or combination thereof.
